(19) United States
(12) Patent Application Publication
(10) Pub. No.: US 2010/0123294 A1
(43) Pub. Date: May 20, 2010

(54) CART FOR ASSISTED PULLING, NON-ASSISTED PULLING, AND POWERED RIDING

(76) Inventors: Eric Ellington, Julian, NC (US); Daniel Lee Ellington, Archdale, NC (US)

Correspondence Address: MACCORD MASON PLLC, 300 N. GREENE STREET, SUITE 1600, P. O. BOX 2974, GREENSBORO, NC, 27402, US

(21) Appl. No.: 12/273,026

(22) Filed: Nov. 18, 2008

(51) Int. Cl. B62B 3/00

(52) U.S. Cl. 280/47.371; 280/47.34; 180/19.3

(57) ABSTRACT

Carts capable of conversion between a powered-pull mode, a powered-ride mode, and a non-powered-pull mode are shown and described. In one embodiment, a cart comprises a platform have a seat-receptacle. A cooler is configured to be positionable in the seat-receptacle. A walled chamber is also positioned on the platform. The cart also includes at least one wheel in functional communication with a drive capable of rotating the wheel. The cart also includes a handle-system having a first operable position configured to allow a user seated inside the cart to control the drive, and a second operable position configured to allow a user walking in front of the cart to control the drive. The cart is further configured to be capable of rolling freely when the drive is off or disengaged.

### FIELD

The present inventions relate generally to carts, and more particularly to powered carts configured for optional riding.

### BACKGROUND

Applicants have invented carts that allow for quick and easy conversion from (1) assisted-pull mode to (2) non-assisted-pull mode to (3) powered-ride mode. Applicants believe these carts will be particularly useful in a variety of areas, including countless recreational events.

By way of example, carts of the instant inventions can be used to provide assisted pulling or powered riding to the beach from nearby locations, such as nearby houses or nearby parking lots. Typically, trips to the beach require a variety of provisions, e.g., coolers, seats, shelters, food, games, fishing equipment, etc. Carrying even a small fraction of these provisions can be difficult. Applicants have found, by using carts of the instant inventions, desired items may be quickly and easily transported to the beach using, for example, the cart's powered-ride mode. In some situations, however, powered riding may not be appropriate. For example, if beach regulations prohibit riding motorized vehicles or restrict motorized vehicle use to particular time periods, users may continue on the beach with the assisted-pull configuration when appropriate. Similarly, some beaches may prohibit all motorized vehicle use. In these situations, users may convert the cart to non-assisted-pull configuration.

Similar uses and situations may exist in a variety of events, including, for example, sporting events, outdoor festivals, farmers' markets, etc.

To briefly summarize some embodiments, carts comprise a platform with a seat-receptacle positioned on the platform. A seat is configured to be positionable in the seat-receptacle. Typical seats will include coolers. In other embodiments, seats may include pedestal seats. Still, some embodiments may include both or additional types of seats. A walled chamber is also positioned on the platform. Typically, the chamber will be defined on one side by the seat and on another side by walls extending up from the platform. Carts usually include at least one wheel in functional communication with a drive capable of rotating the wheel. Many carts will have two wheels in communication with a drive. Carts also include a handle-system. Handle-systems usually have a first operable position configured to allow a user seated inside the cart to control the drive and thereby provide powered riding. Handle-systems also usually have a second operable position configured to allow a user walking in front of the cart to control the drive and thereby provide powered pulling. Typically, the first operable position of the handle-system is configured to allow a user to steer the cart while sitting on the seat, and the second operable position is configured to allow a user to steer the cart while walking in front of the platform.

The above summary was intended to summarize certain embodiments of the present invention. Embodiments of the present invention will be set forth in more detail in the figures and detailed description below. It will be apparent, however, that the detailed description is not intended to limit the present invention, the scope of which should be properly determined by the appended claims.

### BRIEF DESCRIPTION OF THE FIGURES

FIG. 1 shows a front perspective view of one embodiment of the cart;

FIG. 2 shows a different view of the cart of FIG. 1;

FIG. 3 shows a side perspective view of a cart, with the handle-system in the first position, being used by a user;

FIG. 4 shows front perspective view of a cart, with the handle system in the second position, being used by a user;

FIG. 5 shows a partial view of the underside of a cart;

FIG. 6 shows a close-up view of a handlebar; and

FIGS. 7a and 7b show rear and side views, respectively of a cart.

### DESCRIPTION OF TYPICAL EMBODIMENTS

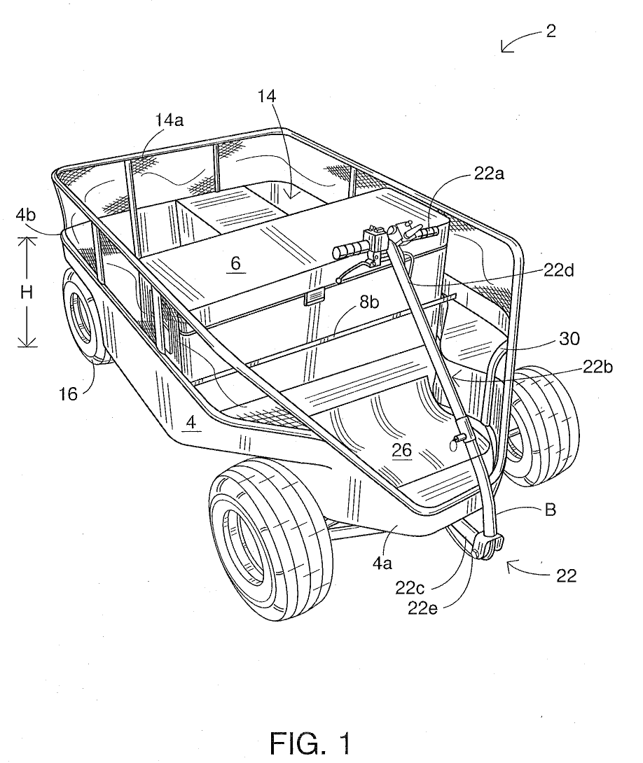

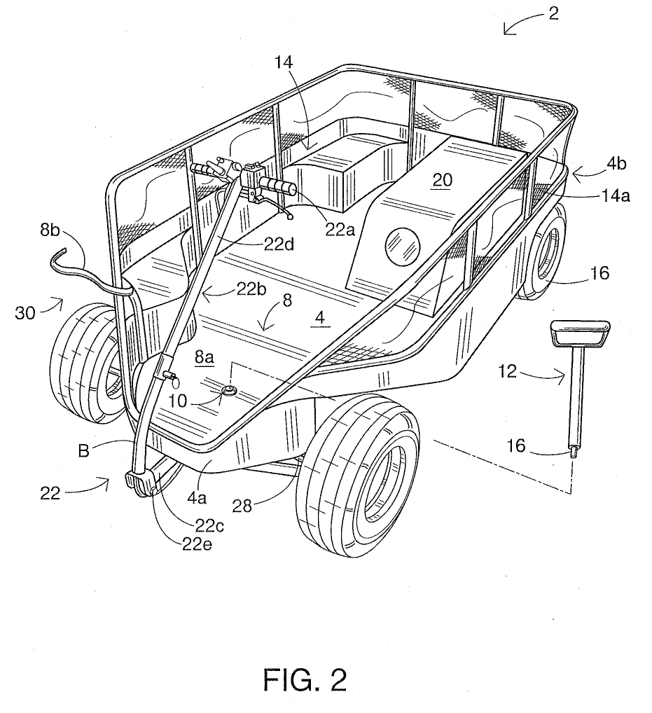

FIG. 1 shows a front perspective view of one embodiment of a cart 2 according to the invention. FIG. 2 shows another view of cart 2 with the seat removed to facilitate viewing. Referring to both FIGS. 1 and 2, cart 2 includes platform 4 having front 4a, back 4b, a length, a width, and a height H. The length of the platform is the distance from front to back and the width of the platform is the distance from side to side.

Cart 2 also includes at least one seat. In FIG. 1, seat 6 is a cooler positioned in seat-receptacle 8 on platform 4. In FIG. 2, cooler 6 is removed to better see, inter alia, seat-receptacle 8. Seat-receptacles may vary from embodiment to embodiment. Typically, seat-receptacles will comprise a space 8a defined by or on platform 4 that is at least large enough to receive a cooler. Seat-receptacle 8 may also include an arm 8b for extending across the width of platform 4 for securing cooler 6. Arm 8b will typically be elastic to allow it to accommodate coolers of a variety of sizes, but in some embodiments, arm 8b may be rigid. Seat-receptacle 8 may also include vertical attachment bars 8c. Attachment bars 8c allow for variable vertical positioning of arm 8b, to accommodate coolers of a variety of sizes.

Cart 2 may optionally include another seat-receptacle, e.g., seat-receptacle 10 shown in FIG. 2. Seat-receptacle 10 is an aperture defined in the base of the platform 4 for engaging with the post 12a of pedestal seat 12. Thus, in these and other embodiments, a user may alternate between one seat and another as needed, e.g., between cooler 6 and pedestal seat 12. Still, in some situations a user may desire to operate a cart without a seat. Other embodiments include other seats and seat-receptacles, e.g., folding beach chairs and clamps configured to hold the chairs. Still, other embodiments may include a single seat-receptacle or may include additional seat-receptacles.

Cart 2 also typically includes walled chamber 14. Typically, walled chamber 14 will be defined at least in part by wall 14a extending up from platform 4, e.g., on three sides as shown. Chamber 14 may further be defined on another side by a seat in a seat-receptacle, e.g, cooler 6. Other embodiments may include more or fewer walls (e.g., the back wall may be omitted), or may include more walls (e.g., a top wall).

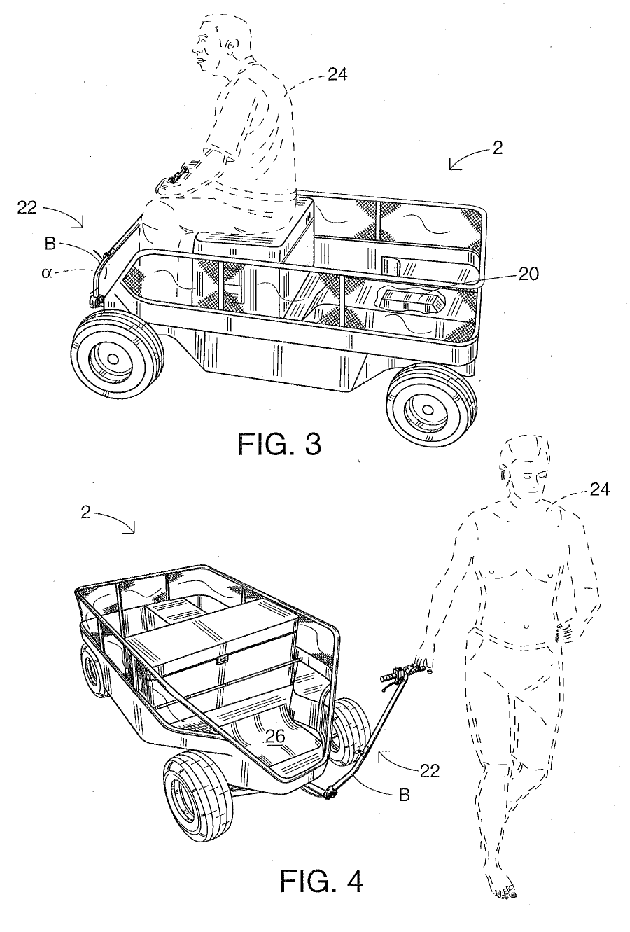

Cart 2 also includes handle-system 22 having a first operable position and a second operable position. FIG. 3 shows cart 2 with handle-system 22 in a first position. Handle-system 22 is configured to allow a user 24 seated inside cart 2 to control drive 20 when in the first position, thereby allowing for powered riding. FIG. 4 shows cart 2 with handle-system 22 in a second position. Handle-system 22 is also configured to allow user 24 to control drive 20 when in the second position, thereby allowing for powered pulling. In addition to being configured to control the drive, the first handle-system position is configured to allow user 24 to steer cart 2 when seated, and the second handle-system position is configured to allow a user to steer cart 2 while walking in front of platform 4.

As seen in FIG. 2, handle-system 22 typically includes handlebar 22a and a tongue 22b. Tongue 22b commonly includes a first-portion 22c functionally connected to front-axel 28, and a second-portion 22d functionally connected to handlebar 22a. In this embodiment, handlebar 22a is fixedly mounted to second-portion 22d of tongue 22b in the t-shaped configuration shown. Typically, first-portion 22c and second-portion 22d are pivotally connected at hinge 22e. In many embodiments, the first-portion of the tongue will be in substantially the same horizontal plane as the front axle (e.g., plus or minus 1 to 5 inches). Somewhat similarly, in many embodiments, the hinge connecting the first- and second-portions of the tongue will be in substantially the same horizontal plane as the front axle. Even more typically, the tongue's first-portion 22c extends in front of platform 4 for a distance and the tongue's second-portion 22d includes bend B to create an angle in the second portion. Typically, such a configuration is desirable for translating the rotation of handlebar 22a to side-to-side linear motion of first-portion 22d, thereby allowing for improved steering.

In most embodiments, handle-system 22 includes a rotating joint configured to allow at least part of said handle-system to rotate, e.g., independent of any steering function. For example in many embodiments, it will be desirable to configure a portion of the handle-system to rotate approximately 180° when moving the handle-system from the first position to the second position. In other embodiments, others may prefer less or more rotation. Referring to FIG. 1, rotating joint 18 can be seen on handle-system 22. In this embodiment, rotating joint 18 is located on the second-portion of the tongue and is configured to allow handlebar 22 to rotate at least approximately 180° from the first position to the second position. This configuration allows the handlebar components to be oriented in substantially the same relative location in the first and second positions. For example, referring to the cart shown in FIG. 1, by tilting the second portion 22d of the tongue forward at hinge 22 and rotating an upper part of the second portion 22d at joint 18, handle-system 22 can be converted to the second position. Most typically, rotating joint 18 will be releasably securable, allowing a user to secure the handlebars of the cart in the first and second positions. In many embodiments, joint 18 will include pin 18a to facilitate releasable securing. In other embodiments, joint 18 may be secured, for example, by clockwise or counterclockwise rotation of a threaded compression collar, or by a spring-loaded locking collar.

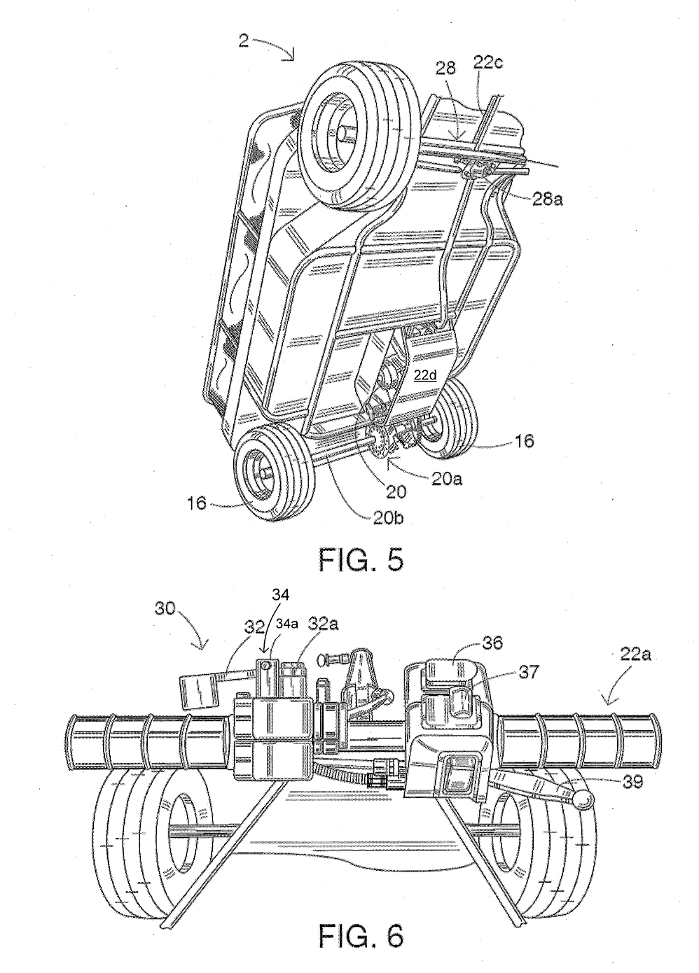

FIG. 5 shows a close-up view of the underside of cart 2. In FIG. 5, the tongue's first-portion 22c can be seen. In addition, it can be seen that first portion 22c is operably connected to steering box 28a of front-axle 28. Others embodiments may include other configurations. Cart 2 also typically includes at least one wheel 16 in functional communication with drive 20 for rotating the wheel. More typically, the two rear wheels of cart 2 to will be driven by drive 20. Drive 20 may include a variety of motors or engines known in the art. In many embodiments, drive 20 will include centrifugal clutch 20a configured to allow the driveshaft 20b to rotate when the motor is turned off or is operating below a certain RPM. Such a configuration is useful, inter alia, to allow a user to pull carts when the drive is off or idling. As can also be seen, in some embodiments, drive 20 will be slightly recessed, or have a portion below the platform, to maximize chamber space and further hide the drive or minimize the cart's appearance of being powered. In such embodiments, sled 22d may be used to further protect or hide the drive. Drives of various embodiments may be gas or electric or a combination thereof.

Referring back to FIGS. 1,2, 3 and 4, tongue 22b is typically bent near point B to create an angle such that handlebar 22a is operationally accessible to a user seated within the cart, e.g., on cooler 6, when handle-system 22 is in the first position (see FIG. 3). Bend B is also useful for placing the handlebar in the desired location when handle-system 22 is in the second position (see FIG. 4). If employed, bend B may vary from embodiment to embodiment, but will typically create an angle a of about 150 degrees to about 170 degrees.

FIG. 6 shows a close-up top view of handlebar 22a including throttle 30 for controlling the output of the drive. Throttles of the instant inventions may vary, but are typically configured to allow a user to control the drive in both the first position and in the second position. In the embodiment shown, the throttle includes lever 32 mounted at point 32a, such that the lever is cantilevered, with the cantilevered portion extending distally. In many embodiments, the lever is positioned at a location on the handlebar such that when the handlebar is in the first position the lever is accessible by the thumb of one hand, e.g., the left hand. When the handle-system is in the second position, it can be appreciated that lever 30 is similarly positioned to be similarly accessible. Referring back to FIG. 6, lever 32 will typically be biased to a closed position, for example, requiring active depression of the lever to power the cart. Other embodiments may include other types of throttles. For example, in other embodiments, handlebars may include a pair of throttles, e.g., one on each handle or two on a single handle, which may be desirable on embodiments lacking a rotating collar to facilitate throttle access. Handlebars will typically be the location of other control components as well.

For example, many embodiments will include a governor-system 34 capable of regulating the cart's drive. Governor-systems are useful, inter alia, to regulate the cart's speed when the handle-system is in the second position. Governor-systems will vary from embodiment to embodiment, and in many embodiments, will be at least partially located on the handle-system. In the embodiment depicted, governor-system 34 includes a rotatable knob 34a, located on the handlebar, which can be manually adjusted to limit the motion of lever 32. For example, the governor-system 34 may include a cam mounted on knob 34a, which through rotation, may block the path of a throttle lever. In many instances, knob 34a is sized and tensioned to be adjusted by hand without the use of tools. The governor-system may also be biased to at least partially block the throttle, such that active manipulation of the governor system is required to achieve higher speeds. In an alternative embodiment, the governor-system may include a position-detecting actuator configured to regulate a throttle when the actuator detects the second position. For example, the position-detection actuator may include a gravity-driven switch, e.g., mercury or swinging-pin, positioned on the handle-system to complete a circuit when the handle-system is in either the first or second position. In other embodiments, the governor-system may include a toggle switch positioned at hinge 22e that is moved by the handle-system's transition from the first position to the second position or from the second position to the first position.

Additionally, it will often be desirable to include starter 36, emergency-stop or kill switch 37, and brake 39. Some embodiments may also include auxiliary switch 38, to control other components, e.g., radio, lights, etc. Typically, it will be desirable to make the kill switch 37 easily accessible to a user when the handle-system is in the second position to allow for rapid turning off or disengagement of the motor. Components 36, 37, 38 and 39 are shown on one side of handlebar 22a (e.g. the right side), but in other embodiments the various components may be on either side or both.

As best seen in FIGS. 1, 2 and 4, cart 2 also typically includes foot-rest 26 positioned in front of a seat-receptacle, e.g., receptacle 8. Foot-rest 26 is typically defined by platform 4 and sized to receive the feet of users sitting in a seat. Cart 2 also typically includes a user-access 30 positioned near the front of platform 4 to allow a user to easily get into and out of cart 2 to transition between the first and second handle positions. User-access is typically defined by walls 14a and may be further defined by platform 4, e.g., by defining a notch in the height of platform 4.

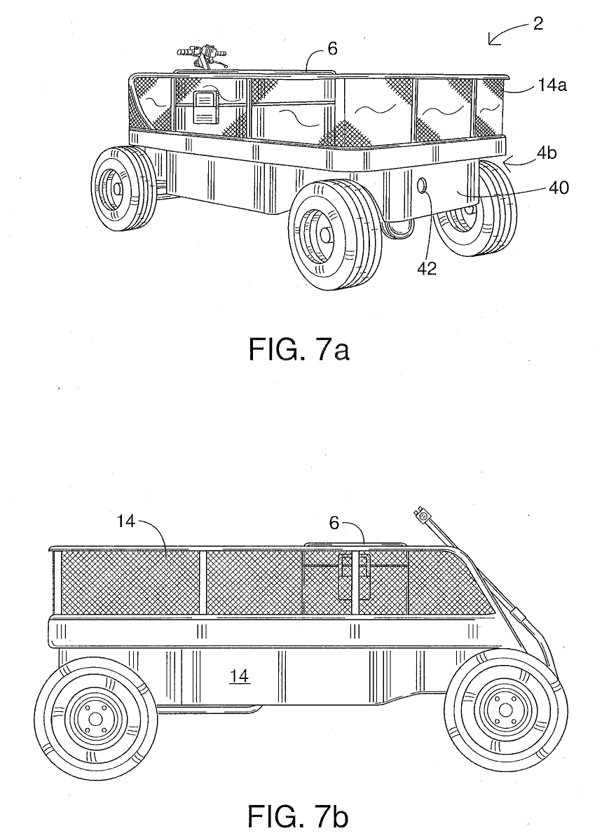

FIGS. 7a and 7b show rear perspective and side views, respectively, of cart 2. In these figures, platform 4 can be seen, along with seat 6, and wall 14a. Additionally, FIG. 7a provides a clear view of aperture 40 defined in platform 4. Positioned within aperture 40 is the exhaust pipe 42 of the cart's drive. Typically, exhaust pipe 42 will be completely contained within the platform such that exhaust pipe 42 does not extend beyond the wall of the platform. For example, in the side view of FIG. 7b, the exhaust pipe cannot be seen. The effect is that the cart can appear to be simply a non-powered cart. This effect is further facilitated by covering the drive, e.g. with portions of the platform or the sled as previously described.

Although carts of the instant invention have a variety of uses, typical embodiments will be particularly useful for those vacationing at the beach. By way of example, many beach-goers travel to the beach from nearby locations, such as nearby houses or parking lots. Using Applicants' cart, food, drink, shelter, seating, games, fishing equipment, water toys, etc., may be quickly transported to the beach using the riding mode. Once to the beach, the handle-system can be converted to the second position to allow for powered pulling or non-powered pulling of the cart and the provisions contained inside it. A user's decision to use powered or non-powered pulling may depend on the regulations at a particular beach. For example, if the beach prohibited motorized vehicles during certain hours, a user could use non-powered pulling during periods of prohibition and powered pulling during periods of restriction-free access. Somewhat similarly, if a beach only prohibited powered riding, a user may use powered pulling to assist in the transport. Additionally, should a user learn on the beach, that powered motor vehicles are prohibited, the user may quickly and easily access a stop-switch located on the handlebar to kill the motor, thereby minimizing the detection of any unintentional infractions. Further, the embodiments having hidden or recessed exhaust pipes and motors are useful for not drawing attention when the cart is being properly used on beaches that prohibit motorized vehicles.

Numerous characteristics and advantages have been set forth in the foregoing description, together with details of structure and function. The novel features are pointed out in the appended claims. The disclosure, however, is illustrative only, and changes may be made in detail, especially in matters of shape, size, and arrangement of parts, within the principle of the invention, to the full extent indicated by the broad general meaning of the terms in which the general claims are expressed. It is further noted that, as used in this specification, the singular forms “a,” “an,” and “the” include plural referents unless expressly and unequivocally limited to one referent.

1) A cart comprising:
a platform having a front, a back, a length, a width, and a height;
a seat-receptacle positioned on said platform and configured to secure a seat;
a seat positionable in said seat-receptacle;
a walled chamber defined on one side by said seat and on another side by walls extending up from said platform;
a least one wheel in functional communication with a drive for rotating said wheel; and
a handle-system having
a first position configured to allow a user seated inside said cart to control said drive, thereby providing powered riding, and
a second position configured to allow a user walking in front of said cart to control said drive, thereby providing powered pulling.

2) The cart of claim 1, including a foot-rest positioned in front of said seat-receptacle, wherein said foot-rest is sized to receive the feet of a user sitting on said seat.

3) (canceled)

4) The cart of claim 1, including a user-access defined by said walls, wherein said user-access is positioned near the front of said platform, thereby allowing a user to transition between said first and said second positions.

5) The cart of claim 1, wherein said first position of said handle-system is configured to allow a user to steer said cart while sitting on said seat, and wherein said second position is configured to allow a user to steer said cart while walking in front of said platform.

6) The cart of claim 1, wherein said handle-system includes a handlebar and a tongue.

7) The cart of claim 6, wherein said tongue includes a first-portion functionally connected to a front-axle, and a second-portion connected to said handlebar.

8) The cart of claim 7, wherein said first-portion and said second-portion of said tongue are pivotally connected.

9) The cart of claim 7, wherein said second-portion includes a rotating joint.

10) The cart of claim 9, wherein said rotating joint is configured to allow said handlebar to rotate at least approximately 180° from said first position to said second position, thereby maintaining said handlebar in a usable position in both said first position and said second position.

11) The cart of claim 7, wherein said rotating joint is configured to be releasably securable, thereby allowing it to be secured in said first position and said second position.

12) The cart of claim 11, wherein said rotating joint configuration includes a pin configured to engage said second-portion of said tongue.

13) The cart of claim 1, wherein said handle-system includes a rotating joint configured to allow at least part of said handle-system to rotate approximately 180°, thereby maintaining said handlebar in a usable position in both said first position and said second position.

14) The cart of claim 7, wherein said handlebar is fixedly mounted to said second-portion of said tongue.

15. (canceled)

16) The cart of claim 6, wherein said handlebar includes a throttle for controlling the output of said drive, wherein said throttle is positioned to allow a user to operate said throttle in said first position, and wherein said throttle is configured to allow a user to operate said throttle in said second position.

17) The cart of claim 16, wherein said throttle includes a lever mounted to said handlebar.

18) (canceled)

19) The cart of claim 1, further including a governor-system capable of regulating said drive, the governor-system including a knob configured to be manually adjustable to govern.

20-32. (canceled)

33) A cart comprising:
a platform having a front, a back, a length, a width, and a height;
a cooler-receptacle positioned on said platform and being sized to receive a cooler;
a foot-rest positioned in front of said cooler-receptacle, wherein said foot-rest is sized to receive the feet of a user sitting on said cooler;
a walled chamber defined on one side by said cooler and on another side by walls extending up from said platform;
a least one wheel in functional communication with a drive for rotating said wheel;
a handle-system including a handlebar and a tongue, said handle-system being configured to transition from a first position configured for a user seated on said cooler to a second position configured for a user walking in front of said cart,
wherein said tongue includes a first-portion functionally connected to a front-axle, and a second-portion connected to said handlebar,
wherein said second-portion includes a rotating joint configured to allow said handlebar to rotate at least about 180° from said first position to said second postion, and
wherein said first-portion and said second-portion are pivotally connected; and
a throttle mounted on said handle system for controlling the output of said drive,
wherein said throttle is configured to allow a user to operate said throttle in said first position, and
wherein said throttle is configured to allow a user to operate said throttle in said second position.

34) (canceled)
